(19) United States
(12) Patent Application Publication
(10) Pub. No.: US 2008/0205711 A1
(43) Pub. Date: Aug. 28, 2008

(54) Biometric information acquisition device

(75) Inventors: Masahiro Kishigami, Ibaraki-shi (JP); Nobuhiro Umebayashi, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., IBARAKI-SHI (JP)

(21) Appl. No.: 12/071,563

(22) Filed: Feb. 22, 2008

(30) Foreign Application Priority Data
Feb. 26, 2007 (JP) 2007-045517

(51) Int. Cl. G06K 9/00

(52) U.S. Cl. 382/115

(57) ABSTRACT

A biometric information acquisition device for acquiring biometric information of a biological portion includes a light emitter to emit an inspection light, a light guide to guide the inspection light from a light incident surface thereof to a light exit surface thereof and to output the guided inspection light to the biological portion through the light exit surface, and an imager to acquire an image by receiving the inspection light from the biological portion, wherein the light output through the light exit surface of the light guide has a substantially equal intensity in a longitudinal direction of the light exit surface.

### BACKGROUND OF THE INVENTION

1. Field of the Invention

The present invention relates to a biometric information acquisition device.

2. Description of Related Art

The progress in the technological development relating to biometric authentication has been significant. As is widely known, the technology relating to biometric authentication is a technique that distinguishes a certain individual from other individuals based on a determination result as to whether the biometric information which is acquired from an inspection targeted individual is equal to prestored biometric information. For example, there are a technique of identifying an individual based on the iris of a human pupil, a technique of identifying an individual based on the vein pattern of a human finger or the like, a technique of identifying an individual based on the fingerprint pattern and so on. Particularly, the technique that uses the vein pattern of a human finger or the like ensures high security because the falsification of pattern data is difficult.

Today, the biometric authentication system is practically used in various situations in everyday life. The biometric authentication system is installed not only in a large scale computer but also in a mobile computer or a mobile communication terminal (cellular phone). Accordingly, there is a strong demand for reducing the size of a biometric information acquisition device which constitutes the biometric authentication system.

Japanese Unexamined Patent Application Publication No. 2001-119008 (which is referred to hereinafter as the patent document 1) discloses an imaging apparatus which is used for the biometric authentication. In this imaging apparatus, the light source (100), the support (300) and the image authentication unit (200) are stacked on top of each other, thereby reducing the size of the imaging apparatus.

In order to reduce the size of the biometric information acquisition device, it is necessary to place the light source and the imaging apparatus in close proximity to each other. However, if the light source and the imaging apparatus are placed in close proximity to each other, the intensity level of the incident light is nonuniform among different portions in the imaging region of the imaging apparatus, which hampers the acquisition of a high quality image.

Thus, the intensity distribution of the reflected light from the living body which is incident on the imaging region of the imaging apparatus includes the distribution due to the biometric information and the distribution due to the nonuniformity of the light intensity level which is caused by the close proximity placement of the light source and the imaging apparatus, which leads to an error in the determination on the biometric information.

According to the patent document 1, the outgoing light which is output from the light source is directly applied to the side of the living body which is placed on the imaging region. Thus, a low quality image is obtained as described above unless some measures are taken to the light source.

### SUMMARY OF THE INVENTION

The present invention has been accomplished to address the above concern, and an object of the present invention is thus to provide a biometric information acquisition device that enables the acquisition of a high quality image even when a light emitter (light source) and an imager are placed in close proximity to each other.

According to an embodiment of the present invention, there is provided a biometric information acquisition device for acquiring biometric information of a biological portion. This biometric information acquisition device includes a light emitter to emit an inspection light, a light guide to guide the inspection light from a light incident surface thereof to a light exit surface thereof and to output the guided inspection light to the biological portion through the light exit surface, and an imager to acquire an image by receiving the inspection light from the biological portion, wherein the light output through the light exit surface of the light guide has a substantially equal intensity in a longitudinal direction of the light exit surface.

The inspection light generated in the light emitter is applied to the biological portion through the light guide. The inspection light having a substantially equal intensity in a longitudinal direction of the light exit surface is output through a prescribed region of the light exit surface of the light guide. Therefore, the reflected light or transmitted light with a uniform intensity is incident on an imaging region of the imager. It is thereby possible to acquire a higher quality image.

It is preferred in the above biometric information acquisition device that the light guide has a light reflective main surface where a plurality of reflective surfaces to reflect the inspection light are arranged continuously in a longitudinal direction of the light reflective main surface. This facilitates the guiding of the inspection light from the light incident surface to the light exit surface. Further, placing the plurality of reflective surfaces appropriately allows the inspection light output through the light exit surface to have a substantially equal intensity in a longitudinal direction of the light exit surface.

It is also preferred in the above biometric information acquisition device that the plurality of reflective surfaces are formed by providing a plurality of grooves on the light reflective main surface. Creating the grooves facilitates the formation of the plurality of reflective surfaces.

It is also preferred in the above biometric information acquisition device that the light guide has a multi-layer structure including a clad layer and a core layer, and the light reflective main surface has a plurality of grooves extending along a stacking direction of the multi-layer structure at least in the core layer. Forming the light guide as the multi-layer structure including the clad layer and the core layer enables the guiding of the inspection light with a low propagation loss.

Preferably, the biometric information acquisition device further includes a light shielding member, and the light shielding member is placed between the light guide and the imaging unit and has an end portion projecting farther than the light exit surface of the light guide. Also preferably, the light shielding member is placed between the light guide and the imaging unit and arranged in such a way that a part of the inspection light output through the light exit surface is directly applied to the light shielding member. Placing the light shielding member reduces the possibility that the inspection light which is output from the light guide is input to the imaging unit without through the biological portion. It is thereby possible to acquire higher quality biometric information.

According to another embodiment of the present invention, there is provided a biometric information acquisition device that includes a first and second light illuminators placed opposite to each other with a surface region to receive light from a biological portion interposed therebetween, wherein each of the first and second light illuminators includes a light emitter to emit the light, and a light guide to guide the light emitted from the light emitter from a light incident surface thereof to a light exit surface thereof in such a way that the light having a substantially equal intensity in a longitudinal direction of the light exit surface is output through the light exit surface.

In each of the light illuminators that are placed opposite to each other with the surface region interposed therebetween, the inspection light emitted from the light emitter is applied to the biological portion through the light guide. Then, the inspection light having a substantially equal intensity in a longitudinal direction of the light exit surface is output through a prescribed region of the light exit surface of the light guide. Therefore, the reflected light or the transmitted light with a uniform intensity is incident on an imaging region of the imaging unit. It is thereby possible to acquire a higher quality image.

It is also preferred in the above biometric information acquisition device that the biometric information acquisition device further includes an imager to acquire an image by receiving the light from the biological portion.

Preferably, each of the first light illuminator and the second light illuminator further includes a light shielding member, and the light shielding member is placed between the light guide and the imaging unit and has an end portion projecting farther than the light exit surface of the light guide. Also preferably, the light shielding member is placed between the light guide and the imaging unit and arranged in such a way that a part of the inspection light output through the light exit surface is directly applied to the light shielding member. Placing the light shielding member reduces the possibility that the inspection light which is output from the light guide is input to the imaging unit without through the biological portion. It is thereby possible to acquire higher quality biometric information.

It is further preferred in the above biometric information acquisition device that, if a width of an interval between an edge of the light guide of the first light illuminator and an edge of the light guide of the second light illuminator placed opposite to each other with the surface region interposed therebetween is W1, and a width of an interval between an edge of the light shielding member of the first light illuminator and an edge of the light shielding member of the second light illuminator placed opposite to each other with the surface region interposed therebetween is W2, 0.5≦W2/W1≦0.9 is satisfied. This further reduces the possibility that the inspection light which is output from the light guide is input to the imaging unit without through the biological portion. It is thereby possible to acquire higher quality biometric information.

It is preferred in the above biometric information acquisition device that the light guide has a light reflective main surface where a plurality of reflective surfaces to reflect the light are arranged continuously in a longitudinal direction of the light reflective main surface. This facilitates the guiding of the inspection light from the light incident surface to the light exit surface. Further, placing the plurality of reflective surfaces appropriately allows the inspection light output through the light exit surface to have a substantially equal intensity in a longitudinal direction of the light exit surface.

It is also preferred in the above biometric information acquisition device that the plurality of reflective surfaces are formed by providing a plurality of grooves on the light reflective main surface. Creating the grooves facilitates the formation of the plurality of reflective surfaces.

It is also preferred in the above biometric information acquisition device that the light guide has a multi-layer structure including a clad layer and a core layer, and the light reflective main surface has a plurality of grooves extending along a stacking direction of the multi-layer structure at least in the core layer. Forming the light guide as the multi-layer structure including the clad layer and the core layer enables the guiding of the inspection light with a low propagation loss.

According to another embodiment of the present invention, there is provided a biometric information acquisition device that includes a surface region to receive light from a biological portion, an imager to acquire an image by receiving the light incident on the surface region, and a plurality of light illuminators placed on periphery of the surface region. Each of the plurality of light illuminators includes a light emitter to emit the light, and a light guide to guide the light emitted from the light emitter from a light incident surface thereof to a light exit surface thereof in such a way that the light having a substantially equal intensity in a longitudinal direction of the light exit surface is output through the light exit surface.

According to the embodiments of the present invention described above, it is possible to provide a biometric information acquisition device that enables the acquisition of a high quality image even when a light emitting unit and an imaging unit are placed in close proximity to each other.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic perspective view of a biometric information acquisition device D1 according to a first embodiment of the present invention;

FIG. 2 is a schematic top view of the biometric information acquisition device D1;

FIG. 3 is a schematic sectional view of the biometric information acquisition device D1 along line 3X-3X in FIG. 2;

FIG. 4 is a schematic diagram of an imaging region of an imaging apparatus;

FIGS. 5A to 5C are schematic illustrations of the structure and the function of a light guide;

FIG. 6 is an illustration showing the divisions which are defined on the light guide;

FIG. 7 is a schematic perspective view of a biometric information acquisition module M1;

FIG. 8 is a block diagram showing the structure of a biometric authentication apparatus;

FIG. 9 is a schematic perspective view of a biometric information acquisition device D2 according to a second embodiment of the present invention;

FIG. 10 is a schematic illustration of the biometric information acquisition device D2;

FIG. 11 is a schematic illustration of the biometric information acquisition device D2; and

FIGS. 12A to 12C are schematic illustrations to explain the variations according to another embodiment of the present invention.

### DESCRIPTION OF THE PREFERRED EMBODIMENTS

Embodiments of the present invention are described hereinafter with reference to the drawings. Each embodiment is simplified for convenience of description. The drawings are given in simplified form by way of illustration only, and thus are not to be considered as limiting the present invention. The drawings are given merely for the purpose of explanation of technological matters, and they do not show the accurate scale or the like of each element shown therein. The same elements are denoted by the same reference symbols, and the redundant explanation is omitted. The terms indicating the directions, such as up, down, left and right, are used on condition that each drawing is viewed from the front.

### First Embodiment

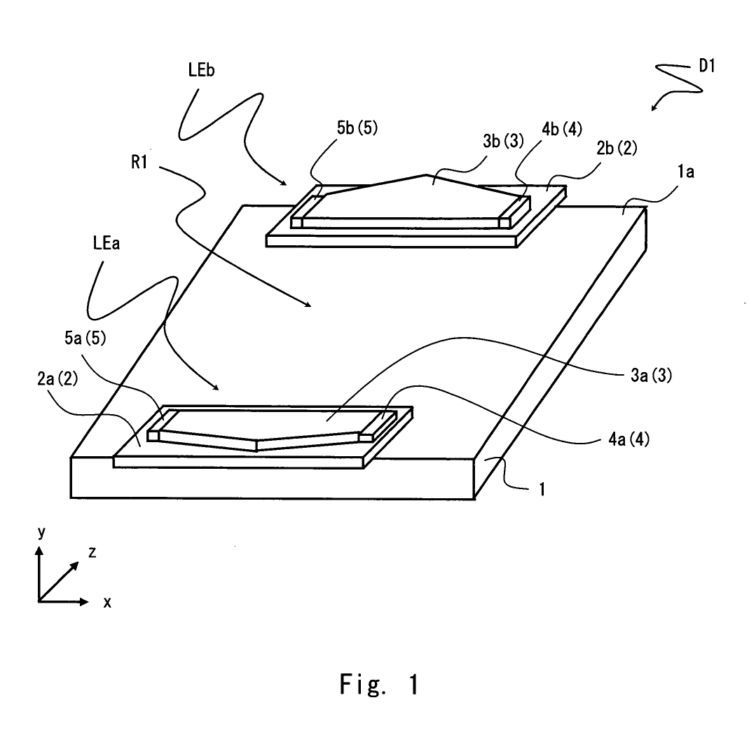

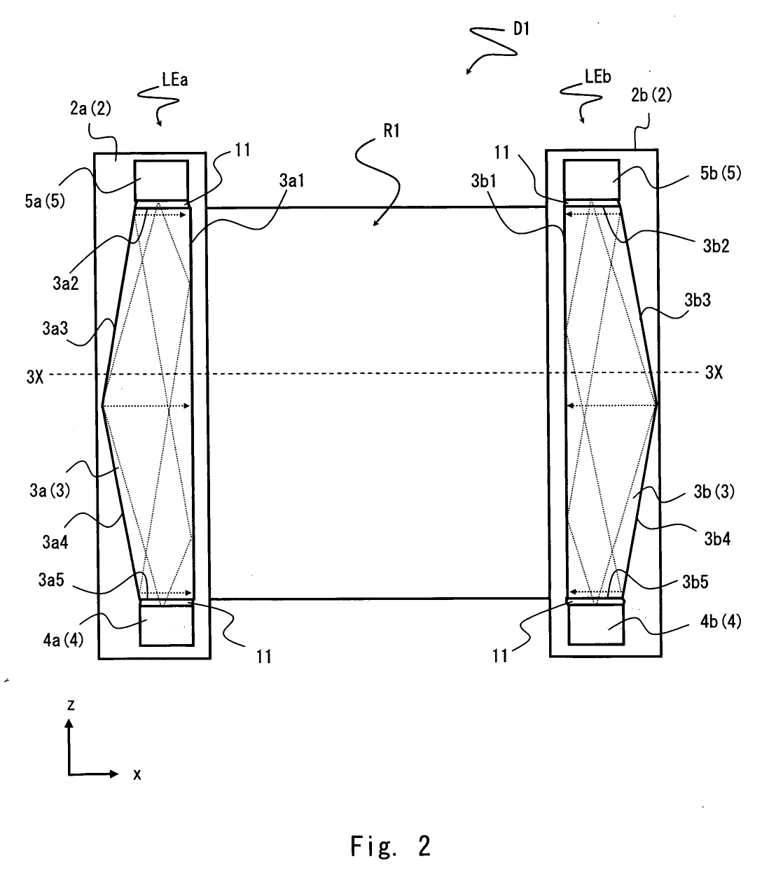

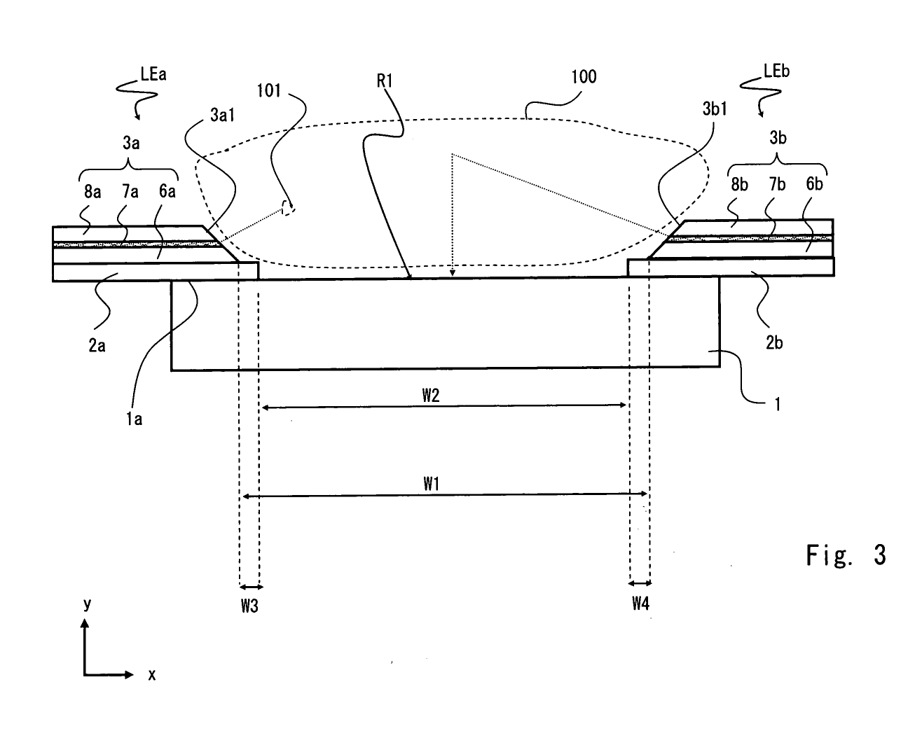

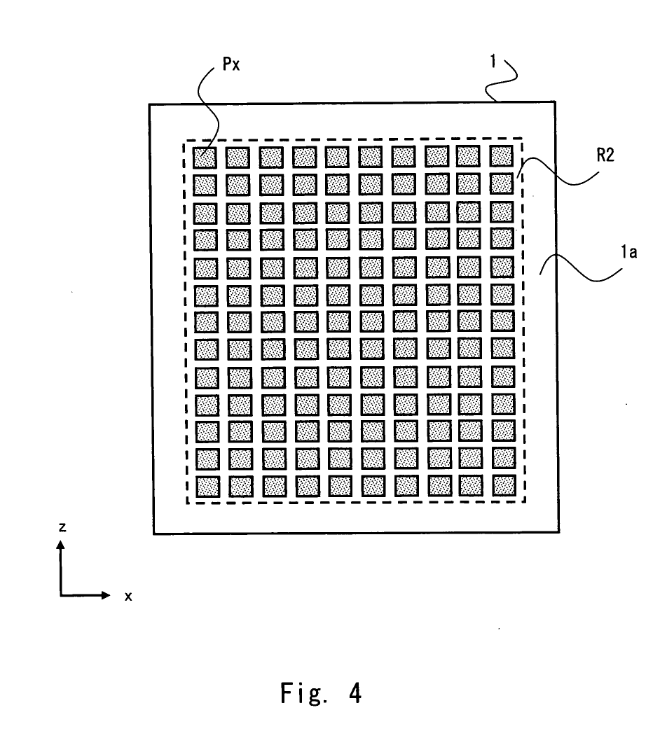

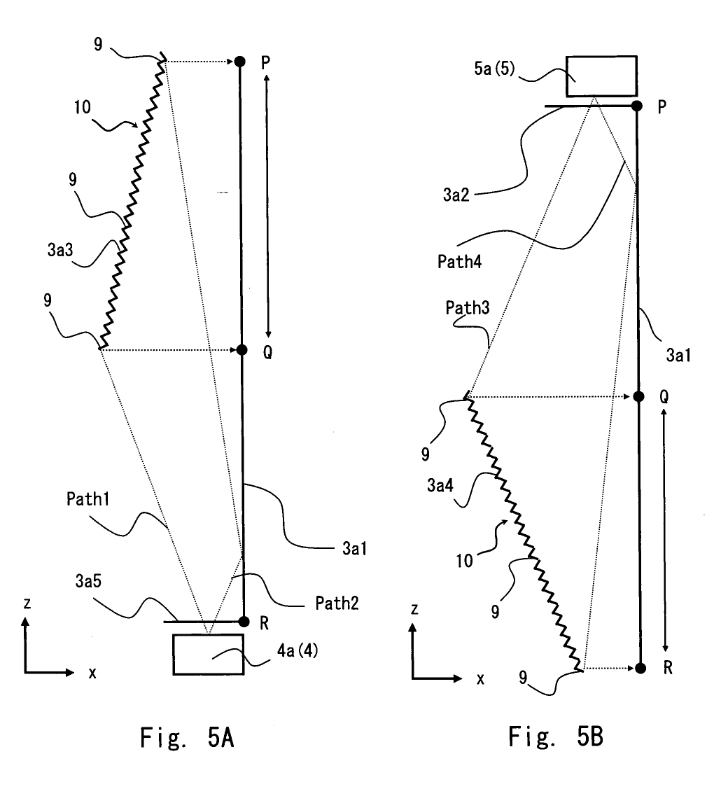

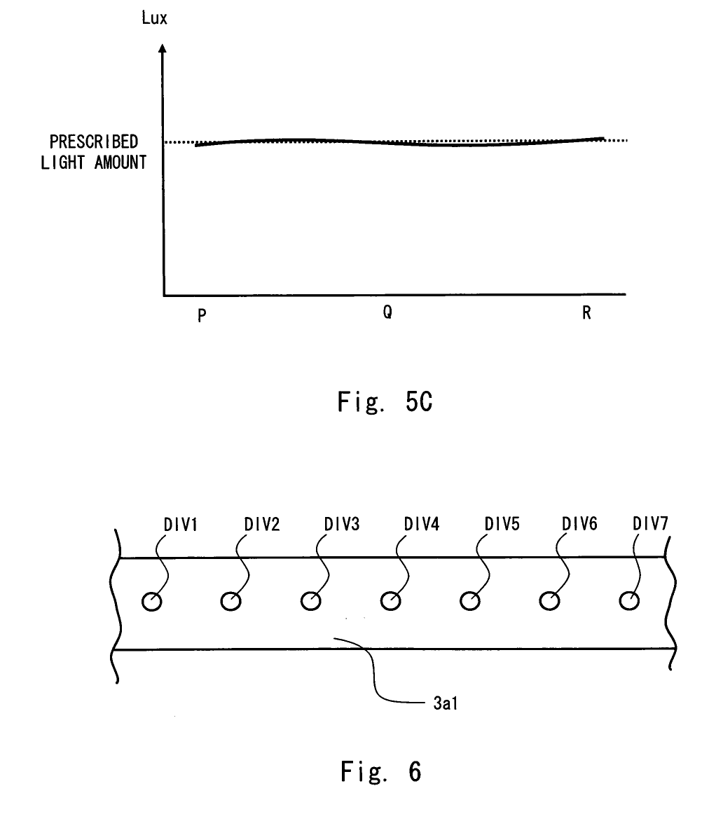

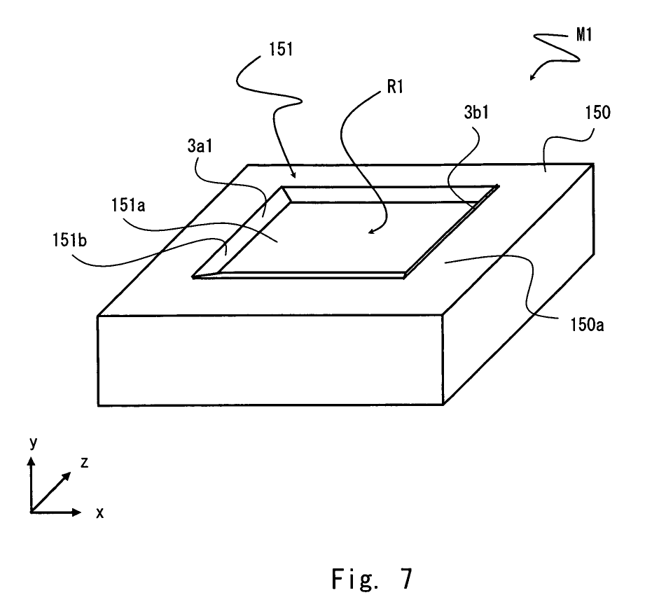

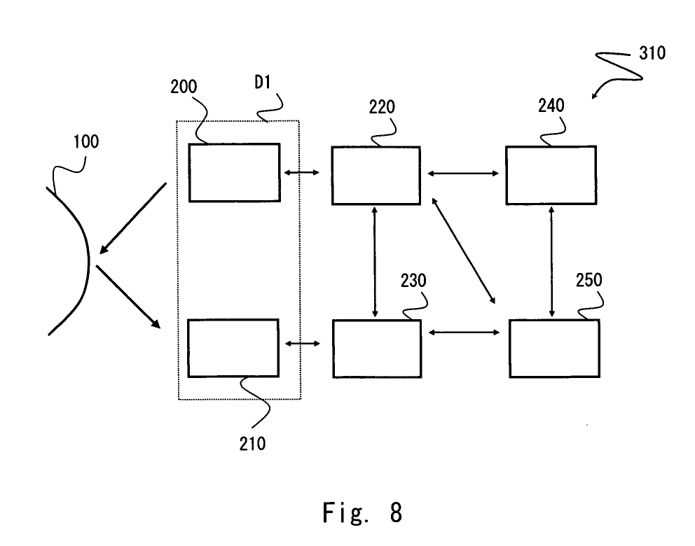

A first embodiment of the present invention is described hereinafter with reference to FIGS. 1 to 8. FIG. 1 is a schematic perspective view of a biometric information acquisition device D1. FIG. 2 is a schematic top view of the biometric information acquisition device D1. FIG. 3 is a schematic sectional view of the biometric information acquisition device D1 along line 3X-3X in FIG. 2. FIG. 4 is a schematic diagram of an imaging region of an imaging apparatus. FIGS. 5A to 5C are schematic illustrations of the structure and the function of a light guide. FIG. 6 is an illustration showing the divisions which are defined on the light guide. FIG. 7 is a schematic perspective view of a biometric information acquisition module M1. FIG. 8 is a block diagram showing the structure of a biometric authentication apparatus.

FIG. 1 is a perspective view schematically showing the biometric information acquisition device D1. As shown in FIG. 1, the biometric information acquisition device D1 includes a thin film transistor (TFT) sensor (imager) 1, a light illuminator (first light illuminator) LEa, and a light illuminator (second light illuminator) LEb.

The light illuminators LEa and LEb illuminate inspection light toward the finger (illustrated in FIG. 3) which is placed on a surface region R1 of the biometric information acquisition device D1. The inspection light is light with a wavelength in the near-infrared region (i.e. 600 nm to 1000 nm). In this example, the wavelength of the inspection light is 760 nm or 870 nm. The inspection light is reflected or scattered within the finger and finally incident on the surface region R1 of a principal surface la of the TFT sensor 1.

The inspection light which is incident on the surface region R1 is received (photoelectrically converted) in each pixel of the TFT sensor 1 and an image is captured by the TFT sensor 1. The inspection light which reaches the vein in the finger is absorbed in the finger vein. Thus, the vein pattern (biometric information) of an inspected person appears on the image which is obtained by the TFT sensor 1. With the use of the image (image information) which is acquired in this manner, it is determined whether the inspected person is a particular specified person.

The TFT sensor 1 is an imaging apparatus which has the principal surface 1a. The TFT sensor 1 is a packaged imaging apparatus. The principal surface 1a of the TFT sensor 1 is the surface of the entrance window of the package. The TFT sensor 1 is an imaging apparatus which is formed by forming a semiconductor layer in the portion corresponding to each pixel on an insulating substrate. A semiconductor substrate is not used for producing the TFT sensor 1, thereby reducing the manufacturing costs.

The principal surface 1a has the surface region R1. The surface region R1 is a surface region of the biometric information acquisition device D1. The inspection light reflected from the finger (biological portion) placed on the surface region R1 is incident on the surface region R1. The imaging region R2 (which is described later with reference to FIG. 4) in the TFT sensor 1 is formed corresponding to the surface region R1.

The light illuminators LEa and LEb are placed on the principal surface 1a of the TFT sensor 1. The light illuminators LEa and LEb are placed opposite to each other with the surface region R1 interposed therebetween.

The light illuminator LEa includes a light shielding plate (light shielding member) 2a, a light guide 3a, a light emitting diode (light emitter) 4a, and a light emitting diode 5a.

The light shielding plate 2a is a plate-like member which is made of a metal material. The light guide 3a, the light emitting diode 4a and the light emitting diode 5a are placed on the light shielding plate 2a. The light guide 3a is a plate-like member. The light emitting diode 4a and the light emitting diode 5a are mounted to the side surfaces of the light guide 3a.

The light illuminator LEb has substantially the same structure as the light illuminator LEa. Specifically, the light illuminator LEb includes a light shielding plate 2b which is the equivalent of the light shielding plate 2a, a light guide 3b which is the equivalent of the light guide 3a, a light emitting diode 4b which is the equivalent of the light emitting diode 4a, and a light emitting diode 5b which is the equivalent of the light emitting diode 5a.

FIG. 2 is a top view schematically showing the biometric information acquisition device D1. As shown in FIG. 2, the light illuminators LEa and LEb are placed opposite to each other with the surface region R1 interposed therebetween.

As shown in FIG. 2, the light illuminator LEa has the light guide 3a, the light emitting diode 4a and the light emitting diode 5a which are placed on the light shielding plate 2a.

The light guide 3a is a plate-like member which has a pentagonal shape when viewed from above. The light guide 3a is substantially transparent to the inspection light (the transmittance is 90% or higher, and it is 99% in this example). The light guide 3a is made of a resin material such as polyimide, for example.

The light guide 3a has a light incident surface 3a2, a light reflective surface (a light reflective main surface) 3a3, a light reflective surface (a light reflective main surface) 3a4 and a light incident surface 3a5.

The light incident surface 3a2 and the light incident surface 3a5 are flat surfaces which are elongated along the X axis as the longitudinal direction. The light emitting diode 5a is mounted to the light incident surface 3a2 with an adhesive 11 interposed therebetween. The light emitting diode 4a is mounted to the light incident surface 3a5 with the adhesive 11 interposed therebetween. In other words, the light emitting diode 5a is optically coupled to the light incident surface 3a2 via the adhesive 11, and the light emitting diode 4a is optically coupled to the light incident surface 3a5 via the adhesive 11.

The adhesive 11 is highly transmissive to the inspection light, and it is substantially transparent to the inspection light. Thus, good optical coupling is established between the light incident surface and the light emitting diode. The light emitting diodes 4a and 5a are packaged monolithic semiconductor devices. The light emitting diodes 4a and 5a emit the light in the near-infrared region (the light with a wavelength of 760 nm or 870 nm) when current is applied thereto.

A light exit surface 3a1 is the side surface which faces the finger (illustrated in FIG. 3) that is placed on the surface region R1. The light exit surface 3a1 is a flat surface which is elongated along the Z axis as the longitudinal direction. The light reflective surface 3a3 and the light reflective surface 3a4 are the side surfaces which are opposite to the light exit surface 3a1. The light reflective surface 3a3 and the light reflective surface 3a4 are also elongated along the Z axis as the longitudinal direction. The light reflective surface 3a3 becomes farther from the light exit surface 3a1 as it extends away from the light incident surface 3a2 along the Z axis. The light reflective surface 3a4 becomes farther from the light exit surface 3a1 as it extends away from the light incident surface 3a5 along the Z axis.

The light guide 3b of the light illuminator LEb has substantially the same structure as the light guide 3a of the light illuminator LEa. Specifically, the light guide 3b has a light exit surface 3b1 which is the equivalent of the light exit surface 3a1, a light incident surface 3b2 which is the equivalent of the light incident surface 3a2, a light incident surface 3b3 which is the equivalent of the light reflective surface 3a3, a light reflective surface 3b4 which is the equivalent of the light reflective surface 3a4, and a light incident surface 3b5 which is the equivalent of the light incident surface 3a5.

The function of the light illuminator LEa is described hereinbelow. The inspection light which is output from the light emitting diode 4a is incident on the light incident surface 3a5 of the light guide 3a through the adhesive 11 and propagates through the light guide 3a along the Z axis, being confined in a core layer 7a (see FIG. 3). The inspection light which is incident on the light incident surface 3a5 is reflected by the light reflective surface 3a3, which is described later, and guided to the light exit surface 3a1.

On the other hand, the inspection light which is output from the light emitting diode 5a enters the core layer 7a (see FIG. 3) of the light incident surface 3a2 of the light guide 3a through the adhesive 11 and propagates through the light guide 3a along the Z axis, being confined in the core layer 7a (see FIG. 3) of the light guide 3a. The inspection light which is incident on the light incident surface 3a2 is reflected by the light reflective surface 3a4, which is described later, and guided to the light exit surface 3a1.

In this embodiment, the inspection light with a substantially equal intensity in the longitudinal direction of the light exit surface 3a1 is output from the core layer 7a of the light exit surface 3a1 of the light guide 3a. In other words, the core layer 7a of the light exit surface 3a1 of the light guide 3a outputs the inspection light which has a substantially equal intensity in the Z axis (the axis orthogonal to the stacking direction of the layers constituting the light guide (i.e. the stacking direction of a multilayer structure)). The range (prescribed region) of the light exit surface 3a1 from which the light which has a substantially equal intensity is output is substantially equal to the width of the light exit surface 3a1. The point (or the mechanism, particularly) that the inspection light with a substantially equal intensity is output in the longitudinal direction of the light exit surface 3a1 is described in detail later with reference to FIGS. 5A to 5C.

The term “substantially equal intensity” allows for some variation in the light intensity. Specifically, the light has the “substantially equal intensity” when the intensity of the light from one division (unit region) is 70% or higher (or 80% or higher, preferably) of the maximum intensity of the light from another division (unit region). Further, the term “equal intensity” also refers to the case where the intensity of the light from one division is 70% or higher (or 80% or higher, preferably) of the maximum intensity of the light from another division. The area of one division and the area of another division are substantially equal.

The light illuminator LEb has the same function as the light illuminator LEa. Specifically, a light emitting diodes 4b is the equivalent of the light emitting diodes 4a, the light incident surface 3b5 is the equivalent of the light incident surface 3a5, the light exit surface 3b1 is the equivalent of the light exit surface 3a1, and the light incident surface 3b3 is the equivalent of the light reflective surface 3a3. Further, a light emitting diodes 5b is the equivalent of the light emitting diodes 5a, the light incident surface 3b2 is the equivalent of the light incident surface 3a2, and the light reflective surface 3b4 is the equivalent of the light reflective surface 3a4.

FIG. 3 is a sectional view showing the biometric information acquisition device D1 along line 3X-3X in FIG. 2. As shown in FIG. 3, the light illuminators LEa and LEb are placed on the principal surface 1a of the TFT sensor 1.

The light illuminator LEa has the light guide 3a on the light shielding plate 2a. The light guide 3a has a multilayer structure in which a clad layer (first clad layer) 6a, the core layer 7a and a clad layer (first clad layer) 8a are stacked on one another along the Y axis. The clad layer 6a and the clad layer 8a have the same refractive index. The refractive index of the clad layer 6a and the clad layer 8a is lower than that of the core layer 7a. This enables effective confinement of the propagating inspection light.

As shown in FIG. 3, the light exit surface 3a1 is tapered in order to reduce the physical stress which is applied to a human finger 100. In other words, the light guide 3a has the surface which is inclined from its top surface to its under surface toward the surface region R1, which is the surface that faces the finger 100 to be placed on the surface region R1, at the edge adjacent to the surface region R1. Thus, the light guide 3a has the tapered-down edge with the thickness (the width along the Y axis) decreasing toward the surface region R1. The top surface of the light guide 3a is narrower than the under surface of the light guide 3a because of the edge which is cut into a tapered shape.

The light shielding plate 2a is a plate-like member which is made of a metal material as described earlier. The light shielding plate 2a is not transparent to the inspection light which is output from the light emitting diodes 4a and 5a. The light shielding plate 2a has the portion which projects toward the surface region R1 from the light exit surface 3a1 of the light guide 3a. In this example, the light shielding plate 2a has the portion which projects toward the surface region R1 (toward the finger (biological portion) to be placed on the surface region R1) farther than the light exit surface 3a1 by the width W3. Because the light shielding plate 2a has the projecting portion, a part of the inspection light which is output from the light exit surface 3a1 toward the surface region R1 is reflected or absorbed by the light shielding plate 2a. In other words, the light shielding plate 2a is placed so that a part of the inspection light which is output from the light exit surface 3a1 is directly applied to the projecting portion of the light shielding plate 2a. The light shielding plate 2a placed in this manner reduces the inspection light which is directly incident on the surface region R1 from the light exit surface 3a1. It is thereby possible to acquire a higher quality image without using a complex image processing technique. The light shielding plate 2a may also have a tapered shape just like the light guide 3a.

The light guide 3b of the light illuminator LEb has substantially the same structure as the light guide 3a of the light illuminator LEa. Specifically, the light guide 3b includes a clad layer 6b which is the equivalent of the clad layer 6a, a core layer 7b which is the equivalent of the core layer 7a, and a clad layer 8b which is the equivalent of the clad layer 8a. Further, the light shielding plate 2b of the light illuminator LEb has substantially the same structure as the light shielding plate 2a of the light illuminator LEa. The light shielding plate 2b has the portion which projects toward the surface region R1 from the light exit surface 3b1 by the width W4. The width W3 and the width W4 are substantially equal in this example.

As schematically shown in FIG. 3, the inspection light output from the core layer 7a of the light exit surface 3a1 of the light illuminator LEa is absorbed by a vein 101 of the human finger 100. On the other hand, the inspection light output from the core layer 7b of the light exit surface 3b1 of the light illuminator LEb is reflected inside the human finger 100 and incident on the surface region R1. As illustrated in the schematic view of FIG. 3, the light exit surface 3a1 is placed to face the side of the human finger 100.

In this manner, the biometric information acquisition device D1 applies the inspection light to the human finger 100 as an inspection target. The inspection light which is reflected by the finger 100 and incident on the surface region R1 is imaged by the TFT sensor 1 having given sensitivity characteristics to the light in the near-infrared region.

The TFT sensor 1 is an imaging apparatus in which semiconductor layers are stacked corresponding to each pixel on an insulating substrate as described earlier. As shown in FIG. 4, the TFT sensor 1 has the imaging region R2 where a plurality of pixels PX are arranged two-dimensionally. Each pixel is composed of a thin film transistor (TFT) as a phototransistor. The imaging region R2 is placed in the area corresponding to the surface region R1.

When the inspection light which is reflected inside the finger is incident on the pixel PX of the TFT sensor 1, a charge corresponding to the intensity of the inspection light is generated in the pixel PX. Then, a signal corresponding to the generated charge is output from the TFT sensor 1, and an image is reconfigured based on the output signal. After that, it is determined whether the observed person is a particular specified person based on a processing result in a processing device in the subsequent stage.

FIGS. 5A to 5C show the illustrations of the structure and the function of the light guide 3a. The structure of the light guide 3b is the equivalent of the structure of the light guide 3a. The function of the light guide 3b is not described herein. FIGS. 5A to 5C are given by way of illustration only.

As schematically shown in FIG. 5A, the light reflective surface 3a3 of the light guide 3a according to this embodiment has a plurality of reflective surfaces 9. The plurality of reflective surfaces 9 are arranged continuously along the longitudinal direction of the light reflective surface 3a3. Further, the light reflective surface 3a3 of the light guide 3a has a plurality of grooves 10 which extend along the Y axis (the axis corresponding to the stacking direction of the layers constituting the light guide). By the grooves 10, the plurality of reflective surfaces 9 are formed on the light reflective surface 3a3. Like the reflective surfaces 9, the grooves 10 are arranged continuously along the longitudinal direction of the light reflective surface 3a3.

The reflective surfaces 9 faces the light incident surface 3a5 and also faces the light exit surface 3a1. The reflective surfaces 9 are arranged so that the inspection light from the light emitting diode 4a is totally reflected. Specifically, the reflective surfaces 9 are arranged so that the incident angle of the inspection light, which is incident on the reflective surfaces 9 from the light emitting diode 4a, is equal to or larger than a critical angle on the reflective surfaces 9. The reflective surfaces 9 totally reflect the inspection light and thereby guide the inspection light from the light incident surface 3a5 to the light exit surface 3a1. Such a structure where the inspection light is totally reflected by the light reflective surface which is placed in the light path from the light incident surface to the light exit surface increases the use efficiency of the inspection light. It also reduces the power consumption of the biometric information acquisition device D1.

As also schematically shown in FIG. 5A, the inspection light made incident on the light incident surface 3a5 is guided to a region between an exit end P and an exit end Q of the light exit surface 3a1. Specifically, the inspection light emitted from the light emitting diode 4a travels along a light path Path 1. The inspection light is then totally reflected by the reflective surface 9 of the light reflective surface 3a3 and guided to the exit end Q of the light exit surface 3a1. Alternatively, the inspection light emitted from the light emitting diode 4a travels along a light path Path 2. The inspection light is then totally reflected by the light exit surface 3a1. Further, the inspection light is totally reflected again by the reflective surface 9 of the light reflective surface 3a3 and guided to the exit end P of the light exit surface 3a1.

In this manner, the inspection light made incident on the light incident surface 3a5 is guided to the light exit surface 3a1 via the plurality of reflective surfaces 9. The inspection light which exits through the area between the exit end P and the exit end Q in the light exit surface 3a1 has a substantially equal intensity in the area between the exit end P and the exit end Q. This is because the reflective surfaces 9 in the light reflective surface 3a3 are arranged in such a way that the intensity of the inspection light which exits between the exit end P and the exit end Q is substantially equal.

The light reflective surface 3a3 may have a circular shape which is convex outward from the light incident surface 3a2 to the light reflective surface 3a4 according to the light intensity distribution of the light emitted from the light emitting diode 4a (i.e. the characteristics of the light emitting diode 4a). Thus, the arrangement and the placement of the reflective surfaces which are included in the light reflective surface 3a3 may be configured appropriately according to the characteristics of the light emitting diode. The structure shown in FIG. 5A is merely an example.

Further, as schematically shown in FIG. 5B, the light reflective surface 3a4 of the light guide 3a according to this embodiment has a plurality of reflective surfaces 9. The plurality of reflective surfaces 9 are arranged continuously along the longitudinal direction of the light reflective surface 3a4. Further, the grooves 10 are also arranged continuously along the longitudinal direction of the light reflective surface 3a4. The reflective surfaces 9 are arranged so that the inspection light from the light emitting diode 5a is totally reflected. The reflective surfaces 9 totally reflect the inspection light and thereby guide the inspection light from the light incident surface 3a2 to the light exit surface 3a1.

As also schematically shown in FIG. 5B, the inspection light made incident on the light incident surface 3a2 is guided to a region between the exit end Q and an exit end R of the light exit surface 3a1. Specifically, the inspection light emitted from the light emitting diode 5a travels along a light path Path 3. The inspection light is then totally reflected by the reflective surface 9 of the light reflective surface 3a4 and guided to the exit end Q of the light exit surface 3a1. Alternatively, the inspection light emitted from the light emitting diode 5a travels along a light path Path 4. The inspection light is then totally reflected by the light exit surface 3a1. Further, the inspection light is totally reflected again by the reflective surface 9 of the light reflective surface 3a4 and guided to the exit end R of the light exit surface 3a1.

In this manner, the inspection light made incident on the light incident surface 3a2 is guided to the light exit surface 3a1 by the plurality of reflective surfaces 9 that are formed on the light reflective surface 3a4. The inspection light which exits through the area between the exit end Q and the exit end R has a substantially equal intensity. This is because the reflective surfaces 9 in the light reflective surface 3a4 are arranged in such a way that the intensity of the inspection light which exits between the exit end Q and the exit end R is substantially equal in the area between the exit end Q and the exit end R.

The light reflective surface 3a4 may have a circular shape which is convex outward from the light incident surface 3a5 to the light reflective surface 3a3 according to the light intensity distribution of the light emitted from the light emitting diode 5a (i.e. the characteristics of the light emitting diode 5a). Thus, the arrangement and the placement of the reflective surfaces which are included in the light reflective surface 3a4 may be configured appropriately according to the characteristics of the light emitting diode.

The structure that allows the output inspection light to have a substantially equal intensity between the exit end Q and the exit end R is not limited to the above structure. The inspection light emitted from the light emitting diode 5a is not necessarily reflected by the light reflective surface 3a4 only, and this inspection light may be partly reflected by the light reflective surface 3a3. Likewise, the inspection light which is emitted from the light emitting diode 4a is not necessarily reflected by the light reflective surface 3a3 only, and this inspection light may be partly reflected by the light reflective surface 3a4.

In this embodiment, the output inspection light has a substantially equal intensity (i.e. the light amount that is substantially equal to a prescribed light amount) in the range between the exit end P and the exit end R of the light exit surface 3a1 as schematically shown in FIG. 5C. In other words, the inspection light with a substantially equal intensity is output in the range (prescribed region) from the exit end P to the exit end R of the light exit surface 3a1 along the longitudinal direction (Z axis direction) of the light exit surface 3a1.

With use of specific values, the additional explanation on the output light with a substantially equal intensity in the longitudinal direction of the light exit surface is follows. The evaluation as to whether the light with a substantially equal intensity is output in the longitudinal direction of the light exit surface is performed by measuring the luminance per division (unit region) which is defined on the light exit surface of the light guide. In the following example, the luminance of divisions DIV1 to DIV7 shown in FIG. 6 was measured using a luminance meter manufactured by TOPCON CORPORATION.

FIG. 6 is a schematic view of the light exit surface 3a1 of the light guide 3a when viewed from the front. As shown in FIG. 6, the light exit surface 3a1 has a plurality of divisions DIV1 to DIV7. The division DIV1 has a diameter of 1 mm. The other divisions DIV2 to DIV7 are similar to the division DIV1. Those divisions are arranged at intervals of 3 mm.

Table 1 shows the measurement result of the luminance of each division. If a minimum luminance (the luminance in the division DIV1) is divided by a maximum luminance (the luminance in the division DIV4), it gives 5320/6350=83.8%. Thus, it is evaluated that the light with a substantially equal intensity in the longitudinal direction of the light guide 3a is output from the light exit surface 3a1 of the light guide 3a in this case.

TABLE 1

| | Division | | | | | | |
|---|---|---|---|---|---|---|---|
| | DIV1 | DIV2 | DIV3 | DIV4 | DIV5 | DIV6 | DIV7 |
| Luminance | 5320 | 5540 | 5920 | 6350 | 5820 | 5630 | 5410 |
| (cd/m²) | | | | | | | |

If the light with a substantially equal intensity in the longitudinal direction of the light exit surface 3a1 is output from the light exit surface 3a1, the inspection light with a more uniform intensity is incident on the imaging region R2 of the TFT sensor 1, which enables the acquisition of a higher quality image. Specifically, it is possible to prevent the inclusion of the nonuniformity in the intensity of the inspection light on the light exit surface of the light guide into the inspection light made incident on the imaging region R2 in addition to the biometric information, thereby avoiding an error caused by that.

Further, as shown in FIGS. 1 to 3, the light shielding plates 2a and 2b are provided to prevent the inspection light output from the light exit surfaces 3a1 and 3b1 from being directly incident on the surface region R1. This suppresses the direct incidence of the inspection light on the surface region R1 from the light exit surfaces 3a1 and 3b1. It is thereby possible to acquire a higher definition image.

Further, in this embodiment, if the interval between the edge of the light guide 3a of the light illuminator LEa and the edge of the light guide 3b of the light illuminator LEb which are placed opposite to each other with the surface region R1 interposed therebetween has a width W1 and the interval between the edge of the light shielding plate 2a of the light illuminator LEa and the edge of the light shielding plate 2b of the light illuminator LEb which are placed opposite to each other with the surface region R1 interposed therebetween has a width W2 as shown in FIG. 3, the relationship of 0.5≦W2/W1≦0.9 is satisfied. In this structure, the inspection light which travels from the light exit surfaces 3a1 and 3b1 toward the surface region R1 can be effectively blocked by the light shielding plates 2a and 2b. It is thereby possible to acquire a higher quality image and reduce the size of the device.

The width W1 of the interval between the edge of the light guide 3a of the light illuminator LEa and the edge of the light guide 3b of the light illuminator LEb is substantially equal to the width of the interval between the light exit surface 3a1 of the light illuminator LEa and the light exit surface 3b1 of the light illuminator LEb. Further, the width W2 of the interval between the edge of the light shielding plate 2a of the light illuminator LEa and the edge of the light shielding plate 2b of the light illuminator LEb is substantially equal to the width of the interval between the end surface of the light shielding plate 2a which faces the surface region R1 and the end surface of the light shielding plate 2b which faces the surface region R1.

Further, in this embodiment, the light illuminators LEa and LEb are placed on the light shielding plates 2a and 2b, respectively, and they are formed as modules to be mounted on the principal surface 1a of the TFT sensor 1. The biometric information acquisition device D1 can be therefore assembled more easily. Further, the light shielding plates 2a and 2b can block the leakage light which leaks from the light guides 3a and 3b which are included in the light illuminators LEa and LEb.

Furthermore, in this embodiment, the width of the interval between the exit end P and the exit end Q is substantially equal to the width of the imaging region R2 of the TFT sensor 1 along the Z axis. This enables the effective use of the imaging region R2 of the TFT sensor 1 and increases the light use efficiency of the inspection light output from the light emitting diode.

In this embodiment, the light illuminators LEa and LEb are placed opposite to each other with the surface region R1 interposed therebetween as described above. Thus, the inspection light with a substantially equal intensity is also output from the light guide 3b of the light illuminator LEb in the range (prescribed region) from the exit end P to the exit end R of the light exit surface 3b1 along the longitudinal direction (Z axis direction) of the light exit surface 3b1. In this structure, the inspection light with a uniform intensity is incident on the entire area of the imaging region R2 of the TFT sensor 1, thereby enabling the acquisition of a higher quality image.

The structure of the biometric information acquisition module M1 in which the biometric information acquisition device D1 is packaged is described hereinafter with reference to FIG. 7.

As shown in FIG. 7, the biometric information acquisition module Ml includes a package 150. The biometric information acquisition device D1 is placed inside the package 150.

The package 150 has a recess 151 in a principal surface 150a. The recess 151 has a substantially rectangular shape when viewed from above, and it has a bottom surface 151a which corresponds to the surface region R1 and four side surfaces 151b which connect the bottom surface 151a and the principal surface 150a. As shown in FIG. 7, the recess 151 has the side surface 151b which corresponds to the light exit surface 3a1 of the light guide 3a.

As described earlier, the light guide 3a and the light guide 3b have the surfaces which are inclined from their top surfaces to their under surfaces toward the surface region R1 at the edges adjacent to the surface region R1. This reduces the physical stress applied to the finger 100 to be placed on the surface region R1 due to the structure of the light guide. Although two light illuminators are placed in the vicinity of the surface region R1 in this example, four light illuminators may be placed so as to surround the perimeter of the surface region R1.

The structure and the operation of a biometric authentication apparatus into which the biometric information acquisition device D1 of this embodiment is incorporated are described hereinbelow with reference to FIG. 8.

As shown in FIG. 8, a biometric authentication apparatus 310 includes a light emitting unit 200 and an imaging unit 210 in the biometric information acquisition device D1, a control unit 220, an image processing unit 230, a storage unit 240, and a collating unit 250. The light emitting unit 200 is the equivalent of the above-described light illuminators LEa and LEb. The imaging unit 210 is the equivalent of the TFT sensor 1. The control unit 220 is communicable with the light emitting unit 200, the image processing unit 230, the storage unit 240 and the collating unit 250.

The light emitting unit 200 emits inspection light toward a living body 100 in response to a control signal from the control unit 220. The inspection light reflected by the living body 100 is incident on the imaging region of the imaging unit 210. The imaging unit 210 is controlled by the image processing unit 230 which is controlled according to a control signal from the control unit 220. The imaging unit 210 enters image acquisition mode or image read mode according to the control signal from the image processing unit 230. The imaging unit 210 may be directly controlled by the control unit 220.

Electrical signals sequentially read from the imaging unit 210 are processed by the image processing unit 230. Image processing may be or may not be performed. Then, the collating unit 250 checks the acquired image information against the image information previously stored in the storage unit 240.

The image information to be collated has the vein pattern (biometric information) of the living body 100. Specifically, the collating unit 250 collates the vein patterns which are contained in the image information with each other and, if the both vein patterns match, determines that the inspected individual is a specified individual. If, on the other hand, the both vein patterns do not match, the collating unit 250 determines that the inspected individual is not a specified individual. The control unit 220 transmits the collating result of the collating unit 250 to another information processing device or the like.

### Second Embodiment

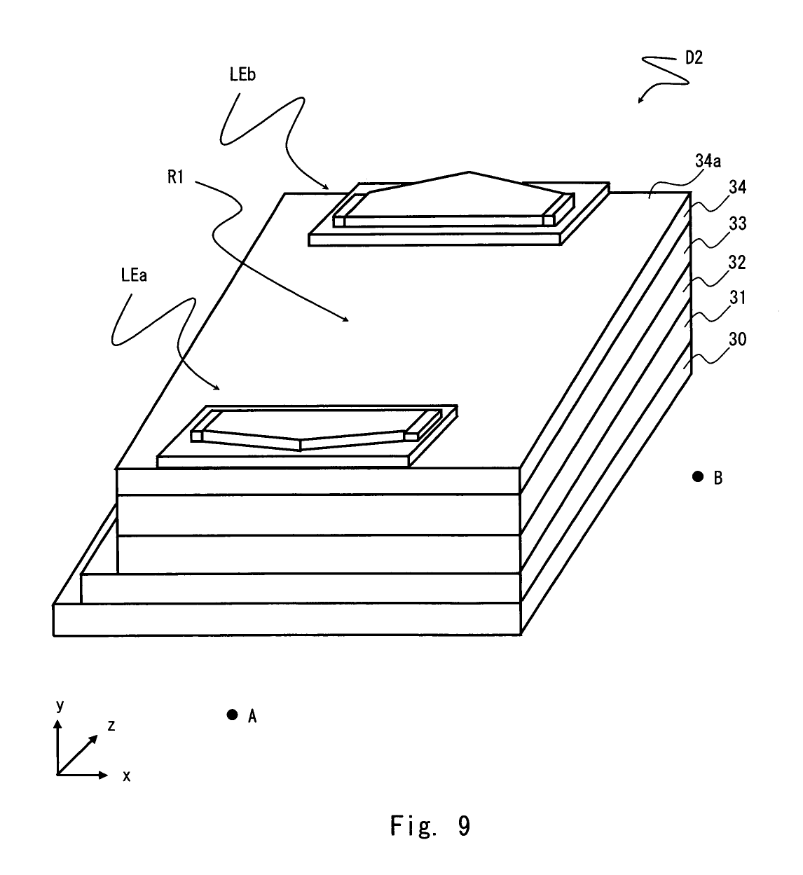

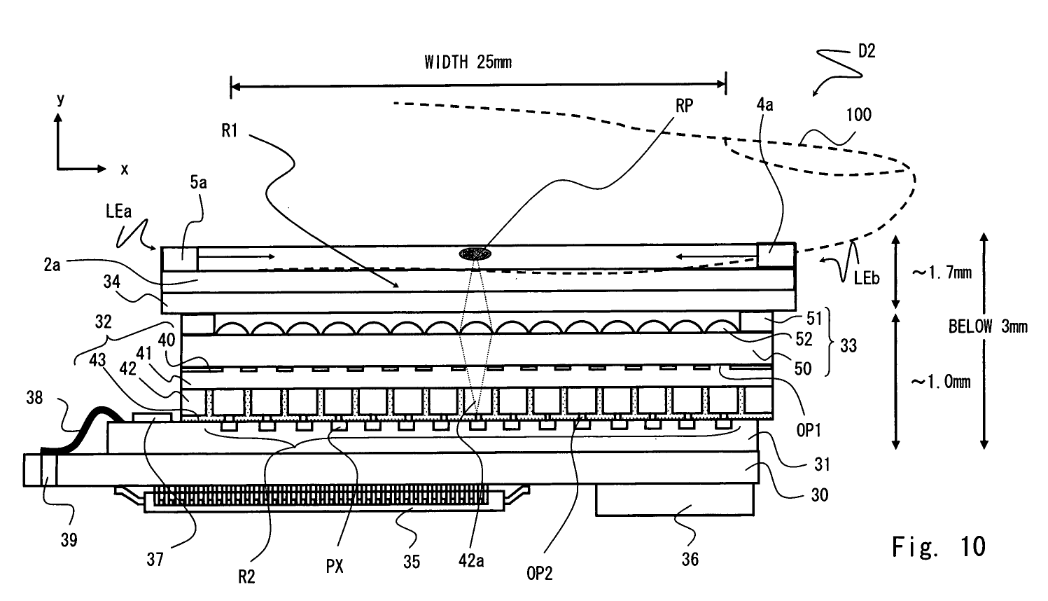

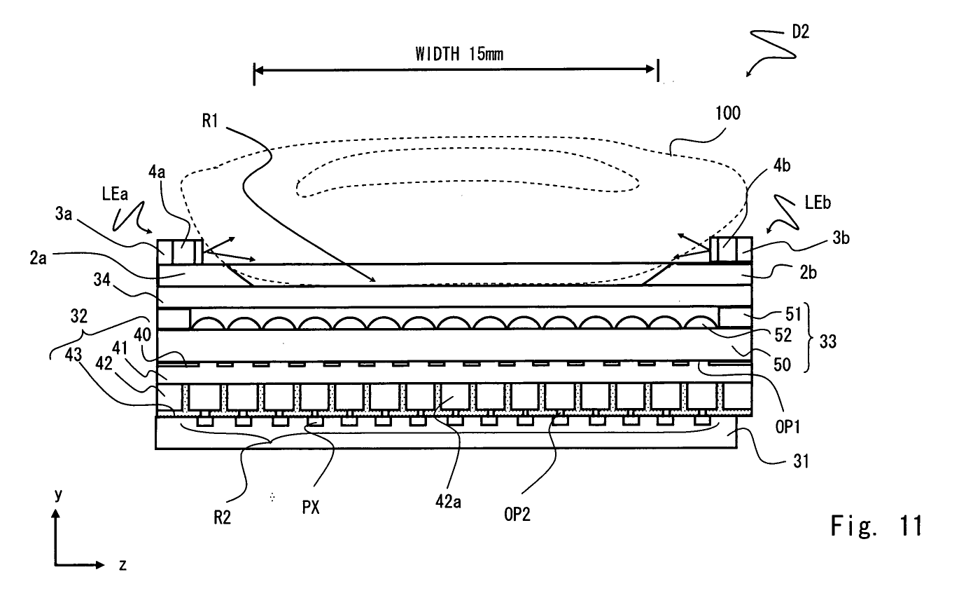

A second embodiment of the present invention is described hereinafter with reference to FIGS. 9 to 11. FIG. 9 is a schematic perspective view of a biometric information acquisition device D2. FIG. 10 is a schematic illustration of the biometric information acquisition device D2 when viewed from the point A of FIG. 9. FIG. 11 is a schematic illustration of the biometric information acquisition device D2 when viewed from the point B of FIG. 9. FIGS. 10 and 11 also show the schematic sectional views of the biometric information acquisition device D2 when viewed from the point A or B for convenience of description.

As shown in FIG. 9, the biometric information acquisition device D2 includes a wiring board 30, a TFT sensor 31, an optical channel separation layer 32, a microlens array 33, a bandpass filter 34, and light illuminators LEa and LEb.

The second embodiment is different from the first embodiment mainly in that the optical channel separation layer 32, the microlens array 33 and the bandpass filter 34 are placed between the light illuminators LEa and LEb and the TFT sensor 31 (which is the same as the TFT sensor 1). This structure enables the acquisition of a higher quality image. Due to the above difference, in this embodiment, the light illuminators LEa and LEb are placed opposite to each other on the bandpass filter 34 with the surface region R1 interposed therebetween. The surface region R1 is a surface region of the biometric information acquisition device D2 on which the inspection light reflected by the finger (or transmitted through the finger) is incident. In this example, the surface region R1 corresponds to a part of the surface of a principal surface 34a of the bandpass filter 34.

FIG. 10 shows the schematic illustration of the biometric information acquisition device D2 when viewed from the point A of FIG. 9. FIG. 11 shows the schematic illustration of the biometric information acquisition device D2 when viewed from the point B of FIG. 9.

As shown in FIG. 10, the TFT sensor 31, the optical channel separation layer 32, the microlens array 33, the bandpass filter 34 and the light illuminators LEa and LEb are stacked in this order on the top surface of the wiring board 30. Further, a semiconductor integrated circuit 35 and a connector 36 are placed on the under surface of the wiring board 30.

The light illuminators LEa and LEb are the same as those described in the first embodiment. In this embodiment, the light shielding plates 2a and 2b have the surfaces which are inclined from their top surfaces to their under surfaces toward the surface region R1 at the edges adjacent to the surface region R1. This inclined surfaces are the surfaces facing the finger 100 to be placed on the surface region R1. In other words, the edges of the light shielding plates 2a and 2b adjacent to the surface region R1 are tapered. Thus, the light shielding plates 2a and 2b have the tapered-down edges with the thickness (the width along the Y axis) decreasing toward the surface region R1. The top surface of the light shielding plate 2a is narrower than the under surface of the light shielding plate 2a because of the edges which are cut into a tapered shape. This is the same for the light shielding plate 2b. Such a structure enables the reduction of the physical stress to the finger 100.

The bandpass filter 34 is a plate-like optical element that allows the band of the near-infrared ray (650 nm to 1000 nm), in which the inspection light is included, to pass through. The light illuminators LEa and LEb are fixed on the top surface of the bandpass filter 34.

The microlens array 33 is placed below the bandpass filter 34. The microlens array 33 includes a transparent substrate 50, a lens (condenser) 52 and a spacer layer 51. A plurality of lenses 52, which are arranged two-dimensionally corresponding to the pixels PX of the TFT sensor 31, and the spacer layer 51 to support the bandpass filter 34 are placed on the top surface of the transparent substrate 50. The transparent substrate 50 and the lenses 52 are made of the material which is substantially transparent to the inspection light. The transparent substrate 50 is a quartz substrate. The lens 52 is an optical element which is formed by partly removing a resist layer that is deposited on the transparent substrate 50 using the photolithography with a grayscale mask.

The optical channel separation layer 32 is placed below the microlens array 33. The optical channel separation layer 32 includes a light shielding film 40, a first transparent layer 41, a second transparent layer 42 and a resist layer 43.

The light shielding film 40 is a layer in which a metal material is formed lattice-like on the under surface of the microlens array 33 using general semiconductor process technologies (e.g. sputtering and vapor deposition). The light shielding film 40 has a plurality of openings OP1 which are arranged in matrix corresponding to the lenses 52 of the microlens array 33. The plurality of openings OP1 are openings in the optical sense. The openings OP1 are filled with the first transparent layer 41 in this example.

The first transparent layer 41 is a layer which is made of a resist (resin material), and it is substantially transparent to the inspection light. The first transparent layer 41 is formed on the under surface of the microlens array 33 after the light shielding film 40 is formed by a general coating technique (e.g. spin coating). The first transparent layer 41 is then heated to lose its viscosity.

The second transparent layer 42 is a resist layer which is made of the same material as the first transparent layer 41. Thus, the second transparent layer 42 is also substantially transparent to the inspection light. The second transparent layer 42 has a plurality of lands 42a. The lands 42a are formed by creating lattice-like grooves in the second layer 42 after the second transparent layer 42 is formed on the under surface of the first transparent layer 41 using a general coating technique (e.g. spin coating). Thus, the plurality of lands 42a which are separated from each other are formed as a result of creating the lattice-like grooves. The separated lands 42a are arranged two-dimensionally corresponding to the pixels PX of the TFT sensor 31. The land is an island-shaped portion which is defined by the groove. The lands are not necessarily completely separated from each other.

The resist layer 43 is filled so as to cover the lands 42a. The resist layer 43 is a resist layer which includes a material that absorbs the inspection light (e.g. phthalocyanine). The resist layer 43 is formed by applying a resist material so as to cover the lands 42a (to fill the grooves which are created in the second transparent layer 42) by spin coating or the like. Further, openings OP2 are formed in a portion of the resist layer 43 by lithography so as to correspond to the light condensing portions of the lenses 52 of the microlens array 33. The openings OP2 also correspond to the positions of the pixels PX of the TFT sensor 31. The openings OP2 are arranged two-dimensionally corresponding to the pixels PX of the TFT sensor 31.

The TFT sensor 31 is placed below the optical channel separation layer 32. The structure of the TFT sensor 31 is the same as the structure of the TFT sensor 1 in the first embodiment. The TFT sensor 31 has the imaging region R2 where a plurality of pixels PX are arranged two-dimensionally on its top surface. Each pixel PX is placed corresponding to each opening OP2 of the resist layer 43. Thus, the light which is condensed by the lens 52 is efficiently incident on the pixel PX.

The imaging region R2 has a larger width along the Z axis than the surface region R1. The imaging region R2 does not correspond to the surface region R1. In this case also, the inspection light from the finger 100 can be imaged by using the part of the imaging region R2 which corresponds to the surface region R1 as an imaging region.

The wiring board 30 is made of a glass epoxy resin or the like, and the elements are mounted onto both top and under surfaces of the wiring board 30.

A drive circuit 37 which controls the read operation or the like of the TFT sensor 31 is placed on the top surface of the TFT sensor 31. The signal which output from the TFT sensor 31 is transmitted to the semiconductor integrated circuit 35 through a wire 38, a through-electrode 39 which connects the top surface and the under surface of the wiring board 30, and a line which is formed on the under surface of the wiring board 30. The connector 36 constitutes an interface to establish the connection between the biometric information acquisition device D2 and an external signal processing circuit.

The semiconductor integrated circuit 35 is an application specific integrated circuit (ASIC). The semiconductor integrated circuit 35 executes prescribed information processing (e.g. determination on the matching between acquired image information and prestored image information). The result of the information processing in the semiconductor integrated circuit 35 is transmitted to another information processing unit (not shown).

As shown in FIG. 10, the thickness from the light illuminators LEa and LEb to the bandpass filter 34 is preferably 1.7 mm or smaller. The thickness from the microlens array 33 to the TFT sensor 31 is preferably 1.0 mm or smaller. The thickness from the light illuminators LEa and LEb to the TFT sensor 31 can be thereby 3 mm or smaller. It is thus possible to achieve a very thin biometric information acquisition device.

Further, as shown in FIG. 10, the width of the surface region R1 along the X axis is 25 mm. As shown in FIG. 11, the width of the surface region R1 along the Z axis is 15 mm. In this configuration, biometric information is collected by placing a finger on the surface region R1 in the manner as schematically illustrated in FIGS. 10 and 11. In such a case, the surface region R1 is covered with the finger. This suppresses the incidence of the external disturbance light onto the surface region R1. In this case, the longitudinal direction of the light exit surfaces of the light illuminators LEa and LEb is oriented opposite to the side surface of the finger. It is thereby possible to apply the inspection light which is output from the light exit surface to the finger at high efficiency.

The function of the biometric information acquisition device D2 is described hereinafter. As schematically shown in FIG. 10, the inspection light which is reflected by an internal region RP of the finger 100 is incident on the pixel PX of the TFT sensor 31 through the lens 52 of the microlens array 33. This is described sequentially hereinbelow. The internal region RP is an area which is about 1 mm in depth from the under surface of the finger 100.

The inspection light output from the light exit surfaces of the light illuminators LEa and LEb is applied to the human finger 100. Inside the human finger 100, the inspection light is reflected by an internal scatterer. The inspection light is absorbed in the vein of the human finger 100. The inspection light transmitted through the human finger 100 is incident on the surface region R1.

The inspection light made incident on the surface region R1 passes through the bandpass filter 34. The external light other than the inspection light is blocked by the bandpass filter 34. Because the bandpass filter 34 filters out noise, it is possible to acquire a higher quality image.

The inspection light which has passed through the bandpass filter 34 enters the microlens array 33. In the microlens array 33, the light is focused toward each pixel PX of the TFT sensor 31 by each lens 52 which is placed on the top surface of the transparent substrate 50.

The light condensed by the lens of the microlens array 33 then enters the optical channel separation layer 32. As described earlier, the optical channel separation layer 32 has the openings OP1 and the openings OP2 which are arranged two-dimensionally corresponding to the pixels of the TFT sensor 31. The optical channel separation layer 32 also has the lands 42a which are arranged two-dimensionally corresponding to the pixels of the TFT sensor 31. The resist layer 43 is filled between the adjacent lands 42a. The resist layer 43 is also formed on the under surface of the lands 42a. In this embodiment, the resist layer 43 contains pigment which absorbs a near-infrared ray. Therefore, the stray light which enters the resist layer 43 is effectively absorbed by the pigment which is contained in the resist layer 43.

In this structure, the optical channel separation layer 32 separates the light paths (optical channels) from the lens 52 of the microlens array 33 to the pixel PX of the TFT sensor 31. Thereby the crosstalk (interference) which can occur between the optical channels is suppressed. The width of the opening OP2 is designed to be narrower than the width of the opening OP1, because the inspection light is condensed as it progresses from the lens 52 to the pixel PX.

The light which enters each pixel of the TFT sensor 31 is photoelectrically converted in the pixel. Then, it is read as an electrical signal and processed in the semiconductor integrated circuit 35 described above. The image which shows the vein pattern of the finger 100 is thereby acquired based on the inspection light which is reflected by the living body.

This embodiment has the same advantages as the first embodiment.

In this embodiment, the bandpass filter 34, the microlens array 33 and the optical channel separation layer 32 are placed between the surface region R1 and the TFT sensor 31. The embodiment thereby enables the acquisition of a still higher quality image compared with the first embodiment.

If the bandpass filter 34, the microlens array 33 and the optical channel separation layer 32 are placed as in this embodiment, the thickness of the biometric information acquisition device D2 increases. However, the thickness from the under surface of the TFT sensor 31 to the top surface of the light illuminator LEa or LEb can be set to about 3 mm or smaller than 3 mm as described above.

### Other Embodiments

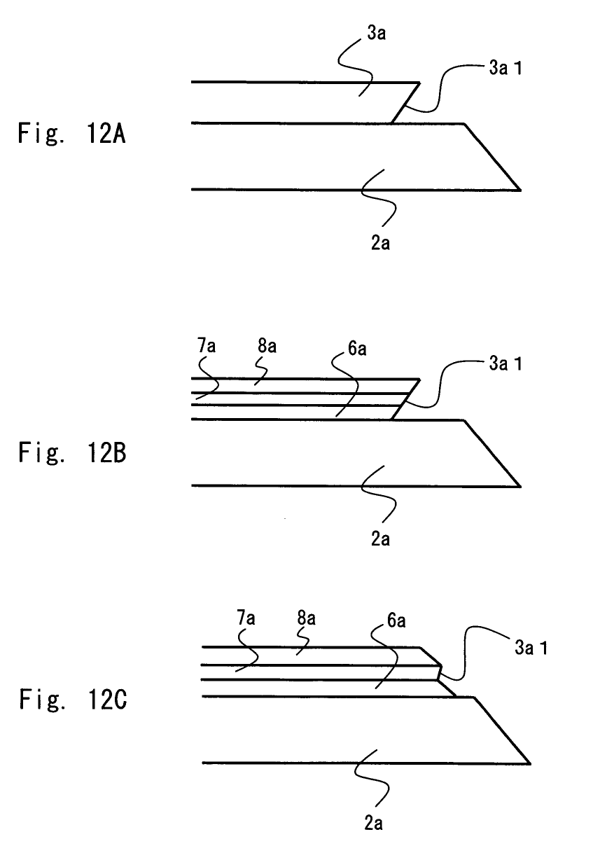

Other embodiments of the present invention are described hereinafter with reference to FIGS. 12A to 12C. A difference from the above-described embodiments is described hereinbelow.

In the structure shown in FIG. 12A, the light guide 3a is configured as a single-layer member. The use of the single-layer light guide 3a also allows the inspection light to propagate at high efficiency by providing appropriate light path design. Further, as shown in FIG. 12A, the light exit surface 3a1 of the light guide 3a is inclined inward of the light guide 3a from the top surface to the under surface of the light guide 3a. In other words, the light guide 3a has a reverse-tapered edge which is adjacent to the surface region R1, and the thickness of the light guide 3a decreases from the under surface to the top surface of the light guide 3a as the light guide 3a extends toward the surface region R1. In this structure, a large part of the inspection light from the light exit surface 3a1 is output upward. It is thereby possible to reduce the inspection light made incident on the surface region R1 without transmitting through the biological portion.

This is applicable to the structure shown in FIG. 12B. Specifically, if the light guide 3a is configured as a multi-layer structure which is composed of the core layer 7a and the clad layers 6a and 8a as shown in FIG. 12B, the light exit surface 3a1 which corresponds to the end surface of the core layer 7a is inclined inward of the core layer 7a from the top surface to the under surface of the core layer 7a. In other words, the core layer 7a of the light guide 3a has a reverse-tapered edge which is adjacent to the surface region R1, and the thickness of the core layer 7a decreases from the under surface to the top surface of the core layer 7a as the core layer 7a extends toward the surface region R1. In this structure, a large part of the inspection light from the light exit surface 3a1 which corresponds to the end surface of the core layer 7a is output upward just like the structure of FIG. 12A. It is thereby possible to reduce the inspection light made incident on the surface region R1 without transmitting through the biological portion.

Further, the description regarding FIG. 12B is applicable to the structure shown in FIG. 12C. The end surface of the light guide 3a which is adjacent to the surface region R1 is not necessarily flush with one another.

The present invention is not limited to the above-described embodiments. The imaging apparatus is not restricted to the TFT sensor, and it may be another general imaging apparatus such as a charge coupled device (CCD), a complementary metal oxide semiconductor (CMOS) or the like. The living body to be inspected is not limited to the finger, and it may be another portion of the living body. The lens and the pixel PX are not necessarily placed in one-to-one correspondence. For example, one lens may be placed in common for a plurality of pixels PX.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A biometric information acquisition device for acquiring biometric information of a biological portion, comprising:
a light emitter to emit an inspection light;
a light guide to guide the inspection light from a light incident surface thereof to a light exit surface thereof and to output the guided inspection light to the biological portion through the light exit surface; and
an imager to acquire an image by receiving the inspection light from the biological portion, wherein
the light output through the light exit surface of the light guide has a substantially equal intensity in a longitudinal direction of the light exit surface.

2. The biometric information acquisition device according to claim 1, wherein
the light guide has a light reflective main surface where a plurality of reflective surfaces to reflect the inspection light are arranged continuously in a longitudinal direction of the light reflective main surface.

3. The biometric information acquisition device according to claim 2, wherein
the plurality of reflective surfaces are formed by providing a plurality of grooves on the light reflective main surface.

4. The biometric information acquisition device according to claim 2, wherein
the light guide has a multi-layer structure including a clad layer and a core layer, and
the light reflective main surface has a plurality of grooves extending along a stacking direction of the multi-layer structure at least in the core layer.

5. The biometric information acquisition device according to claim 1, further comprising:
a light shielding member placed between the light guide and the imager and having an end portion projecting farther than the light exit surface of the light guide.

6. The biometric information acquisition device according to claim 1, further comprising:
a light shielding member placed between the light guide and the imager and arranged in such a way that a part of the inspection light output through the light exit surface is directly illuminated to the light shielding member.

7. A biometric information acquisition device comprising:
a first and second light illuminators placed opposite to each other with a surface region to receive light from a biological portion interposed therebetween, wherein
each of the first and second light illuminators includes:
a light emitter to emit the light; and
a light guide to guide the light emitted from the light emitter from a light incident surface thereof to a light exit surface thereof in such a way that the light having a substantially equal intensity in a longitudinal direction of the light exit surface is output through the light exit surface.

8. The biometric information acquisition device according to claim 7 further comprising:
an imager to acquire an image by receiving the light from the biological portion.

9. The biometric information acquisition device according to claim 8, wherein
each of the first and the second light illuminators further includes:
a light shielding member placed between the light guide and the imager and having an end portion projecting farther than the light exit surface of the light guide.

10. The biometric information acquisition device according to claim 8, wherein
each of the first and the second light illuminators further includes:
a light shielding member placed between the light guide and the imager and arranged in such a way that a part of the light output through the light exit surface is directly illuminated to the light shielding member.

11. The biometric information acquisition device according to claim 9, wherein
if a width between an edge of the light guide of the first light illuminator and an edge of the light guide of the second light illuminator placed opposite to each other with the surface region interposed therebetween is W1, and a width between an edge of the light shielding member of the first light illuminator and an edge of the light shielding member of the second light illuminator placed opposite to each other with the surface region interposed therebetween is W2, 0.5≦W2/W1≦0.9 is satisfied.

12. The biometric information acquisition device according to claim 7, wherein
the light guide has a light reflective main surface where a plurality of reflective surfaces to reflect the light are arranged continuously in a longitudinal direction of the light reflective main surface.

13. The biometric information acquisition device according to claim 12, wherein
the plurality of reflective surfaces are formed by providing a plurality of grooves on the light reflective main surface.

14. The biometric information acquisition device according to claim 12, wherein
the light guide has a multi-layer structure including a clad layer and a core layer, and
the light reflective main surface has a plurality of grooves extending along a stacking direction of the multi-layer structure at least in the core layer.

15. A biometric information acquisition device comprising:
a surface region to receive light from a biological portion;
an imager to acquire an image by receiving the light incident on the surface region; and
a plurality of light illuminators placed on periphery of the surface region, each of the plurality of light illuminators including:
a light emitter to emit the light; and
a light guide to guide the light emitted from the light emitter from a light incident surface thereof to a light exit surface thereof in such a way that the light having a substantially equal intensity in a longitudinal direction of the light exit surface is output through the light exit surface.
